(19) United States
(12) Patent Application Publication
(10) Pub. No.: US 2005/0168855 A1
(43) Pub. Date: Aug. 4, 2005

(54) Assembly for the hinged connection of a rear view mirror

(75) Inventors: Philippe Fanelli, Gis Les Nobles (FR); Cristophe Valade, Arraye et Han (FR)

Correspondence Address: BLACK LOWE & GRAHAM, PLLC, 701 FIFTH AVENUE, SUITE 4800, SEATTLE, WA, 98104, US

(73) Assignee: Fico Mirrors, S.A., Barcelona (ES)

(21) Appl. No.: 10/772,158

(22) Filed: Feb. 4, 2004

(51) Int. Cl. G02B 7/182

(52) U.S. Cl. 359/881; 359/871

(57) ABSTRACT

It comprises a swivel pin (1) coaxially inserted through a holed element connected to the frame of said mirror, said swivel pin having at a first end (1a) a flange (4) and at a second end (1b) at least a retaining configuration (3) adapted for being fixed on a corresponding retaining configuration of a base connected to a vehicle, an elastic member being arranged between said flange (4) and a support of said holed element. Said elastic member comprises a hollow cylinder (5) of moulded plastic material arranged as a skirt, from the peripheral edge (4) towards said second end (1b) of the swivel pin (1), coaxially to it, said hollow cylinder (5) being provided with at least one opening (6) defining at least one helical strip (7) suitable to provide the hollow cylinder (5) with an elastic property.

### FIELD OF THE INVENTION

This invention refers to an assembly for carrying out the hinged connection of an outer rear mirror of a vehicle and namely an elastic member acting on said assembly.

The invention is useful in the field of the car industry.

### BACKGROUND OF THE INVENTION

Cars have usually at least a rear view mirror located outside on one side of the vehicle to allow the driver to see backwards, a lane of the road adjacent to the lane along which the vehicle is been travelling. This kind of mirror comprises a reflecting element or mirror proper, mounted on a frame which is in turn connected to a base fixed on the side of the vehicle. In operation, the mirror frame takes a stationery position with respect to the base and hand or power-driven means allow the user to chose the orientation of the reflecting element with respect to the mirror frame to adjust the visual angle thereof. The mirror frame, in operation, is placed on the side of the vehicle crosswise this later and this situation has the drawback, namely, when manoeuvring in narrow passageways or when the vehicle is parked, that the mirror frame can easily knock down an object, a person or a vehicle or be knocked down by them, which can carry the rear view mirror breakage and/or damage to other vehicles and/or injuries to a pedestrian.

To overcome this drawback, a hinged connection is known of the rear view mirror frame having the base fixed outside the vehicle, offering at least two stable positions for the frame: a position in operating condition in which the frame is placed crosswise on the side of the vehicle; and a parking position in which the frame is bent backwards against the side of the vehicle so that the frame is slightly or even not at all protruding and the reflecting element remains in the front on the side of the vehicle and protected. Passing from a position to the other is carried out by hand overcoming the force of an elastic member. Usually, the frame can also turn once for safety purpose folding in the opposite direction overcoming said elastic force which has the effect of giving away when turning when any contact occurs before breaking or causing damages to persons or objects. The rotation in that parking position has also said safety function when the contact occurs in the opposite direction.

EP-A-0807551 discloses an outer rear mirror of a car equipped with a hinged connection assembly comprising a swivel pin coaxially inserted though a holed element, such as a ring, connected to a frame of said rear view mirror, said swivel pin having at a first end a flange and at a second end at least a retaining configuration adapted for fixing to a corresponding retaining configuration of a base connected to the vehicle. Between said flange and a support of said ring there is an elastic member which acts by compression in a direction parallel to said swivel pin axis to secure a contact under pressure between a lower part of the ring and a seat of said base, with the possibility of turning within an angle limited by respective stops. At said lower part of the ring and at the seat of said base complementary slots and tongues are located, having tilted edges which can be nested to provide the stable positions disclosed below. When, with the hand, the frame is forced to turn said tilted edges slide axially moving the ring against the force of the elastic spring until the tongues of one of them lift and slide on the tongues of the other allowing it to turn while being folded.

The elastic member used in that patent is a conventional compression helical spring made of a spring steel generally including an anti-rust surface treatment. The production of said spring is relatively expensive and due to its helical shape, its handling is discomforting which makes the assembly mounting operations difficult.

An object of this invention is to offer an assembly for the hinged connection of the rear view mirror provided with an elastic member which can be produced at a very low cost.

Another object of this invention is to provide an assembly for the hinged connection of a rear view mirror provided with an elastic member which can be easily and effectively used to facilitate mooting the assembly.

Said aims are achieved according to this invention, providing an assembly for the hinged connection of an outer rear view mirror on the side of a vehicle of the kind disclosed in above-mentioned patent.

### SUMMARY OF THE INVENTION

The assembly according to this invention is characterized in that the elastic member comprises a hollow cylinder of moulded plastic material provided with at least one opening having the suitable configuration to give to the hollow cylinder said compression elastic property significantly in a direction parallel to the swivel pin axis. Said elastic hollow cylinder is arranged coaxially to the swivel pin as a skirt, from a peripheral edge of the flange existing on a first end of the swivel pin towards the second end thereof where it meets said ring support. As used in this description the term “ring” intends to comprise any strip of material arranged around a hole and it can appear for example under the configuration of a plate connected to the frame and in which a hole has been pierced or an internal flange has being arranged at the lower end of a sleeve connected to the frame.

Said opening of the cylindrical body can be a single one, having an helical shape, so that it defines within the hollow cylinder a top ring and a lower ring connected to each other by at least an helical strip although it is preferred that the hollow cylinder comprises two or more helical openings and defining there a top ring and a lower ring connected to each other by as many helical strips. In another even more preferred embodiment, the helical strips left within the hollow cylinder have opposite helix directions and are crossing each other integrating each other in crossing areas, It is achieved defining a plurality of openings having a substantially rhombic shape distributed in a staggered arrangement throughout the hollow cylinder wall. Said configuration in helical strips having opposite helix direction and integral crossing areas provide more force and are evenly distributed.

According to a first example of embodiment, said elastic skirt-shaped hollow cylinder is independent from the swivel pin, therefore this later can be of any suitable material. According to a second example of embodiment, the swivel pin is hollow, of same moulded plastic material as the hollow cylinder and said skirt-shaped hollow cylinder is integral with the swivel pin, said top ring of the skirt being preferably built in said peripheral edge of the flange.

The plastic material out of which the elastic hollow cylinder is made, and eventually the swivel pin is a High Tech plastic material having the characteristics of elasticity and strength required and it can be injection moulded. In the second example of embodiment, in which the elastic hollow cylinder is integral with the swivel pin, a compound will be chosen for said plastic material which possesses a low coefficient of friction with the material of the ring because there will exist a relative sliding motion with the material of the ring because there will exist a sliding relative motion between a end of the hollow elastic cylinder and the support of the ring.

The fact that the elastic member of the assembly of the invention is obtained by plastic material injection moulding allows that it is produced at low cost. Said elastic configuration of the hollow cylinder based on rhombic openings evenly arranged allows that it is more easily handled because they do not tend to entwist their spires with that of other elastic elements stored together that conventional helical springs have. In addition, the fact that the elastic member is integral with the swivel pin reduces the number of components to be produced, checked, stored and assembled which in turn cut downs the final cost of the assembly.

### BRIEF DESCRIPTION OF THE DRAWINGS

Said advantages and characteristics will be more apparent in the detailed description below of preferred examples of embodiment with reference to the drawings attached in which:

FIG. 1 is a lengthwise section elevation lengthwise part view of an assembly for the hinged connection of a rear view mirror according to the state of the art;

FIG. 2 is a view in perspective of an elastic member and a swivel pin according to a first example of embodiment of the assembly for the hinged connection of a rear view mirror according to the invention;

FIG. 3 is a view in perspective of an assembly of elastic member and swivel pin integrated in a single piece according to a second example of embodiment of the assembly according to the invention;

FIG. 4 is a plan view from below of the assembly of elastic member and the swivel according to FIG. 3.

### DETAILED DESCRIPTION OF EXEMPLARY EMBODIMENTS

In the figures same numerals have been used for analogous elements.

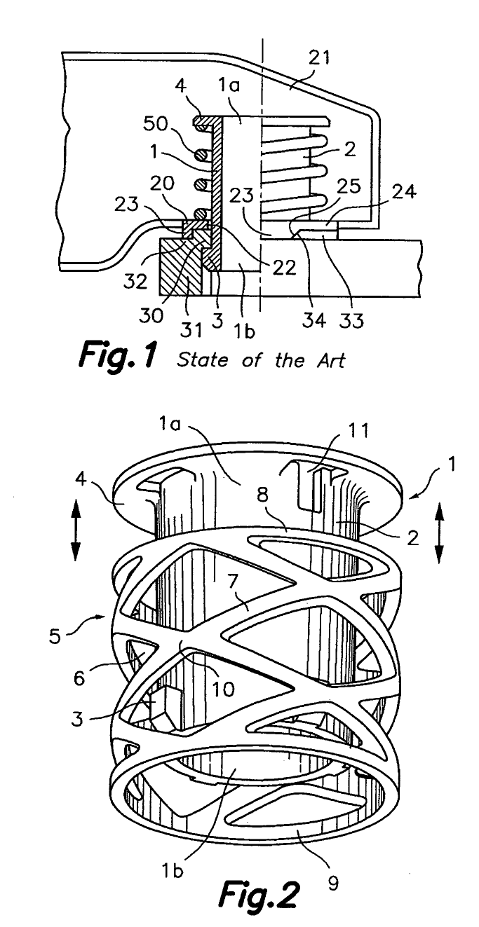

Referring first to FIG. 1, it shows an assembly for the hinged connection of a rear view mirror of the state of the art comprising a swivel pin 1 which has a flange 4 at a first end 1a and at a second end 1b, at least a retaining shape 3 adapted for fixing, for example a bayonet lock or the like, to a corresponding retaining shape 30 provided on a base 31 connected to a vehicle (not shown). Said swivel 1 is preferably hollow and possesses an external surface of revolution 2, for example cylindrical or slightly conical, coaxially inserted through a holed element such as a ring 20 which is connected to or integral with a frame 21 of said rear view mirror. Said ring 20 comprises a support 22 and a lower part 23 which is supported on a seat 32 of said base 31. Between said flange 4 and said support 22 of the ring 20 an helical spring 50 in steel is arranged which acts by compression in a direction parallel to the axis of the swivel pin 1 to secure a contact under pressure between said lower part 23 of the ring 20 and said seat 32 of the base 31, said contact under pressure allowing a rotation of the ring 20 and, therefore, of the frame 21 with respect to the base 31 within an angle limited by respective stops (not shown). In some applications, said ring 20 is located at the lower end of a sleeve within which the assembly of the swivel pin 1 and the spring 50 are housed, although said sleeve is not essential.

At said lower part 23 of the ring 20 and in said seat 32 of the base 31, respective complementary slots 24 and tongues 33 are located which can be nested to provide stable positions above disclosed. Said slots 24 and tongues 33 have respective tilted side edges 25 and 34 which when the rotation of the frame 21 with respect to the base 31 is forced by hand, slide ones on the others moving the ring 20 axially against the force of the spring 50 until the lower part 23 of the ring 20 lifts and slides on the tongues 33 and the base 31 allowing folding rotations disclosed with respect to the state of the art.

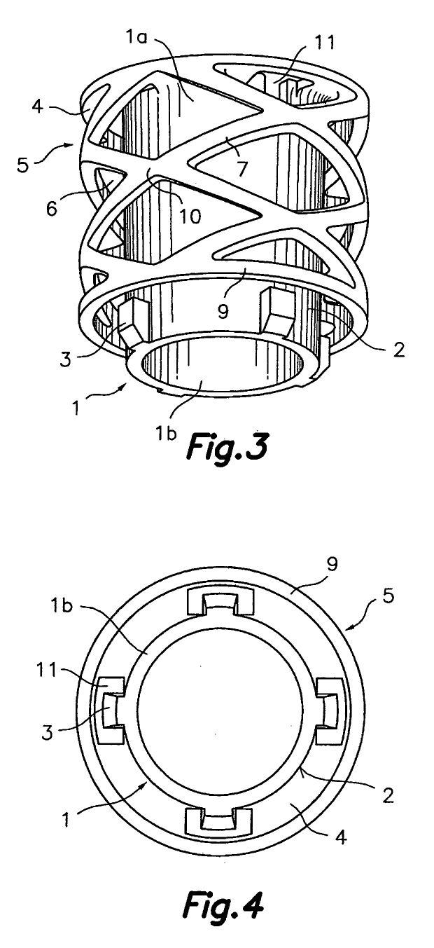

The device of this invention is of the kind disclosed above and it is characterized in that the helical spring 50 in steel is replaced by an elastic member 5 the characteristics of which are disclosed below. FIGS. 2 and 3 show, respectively, a first and a second examples of embodiment of the assembly of elastic member 5 and swivel pin 1 of the device of this invention.

Referring now to FIG. 2, said elastic member comprises, according to a first example of embodiment, a hollow cylinder 5 in moulded plastic material which, when operating, is arranged as a skirt coaxial around the trunk of the swivel pin 1 from a peripheral edge of the flange 4 existing at said first end 1a thereof and towards the second end 1b of the swivel pin 1 where it is located with the support 22 of the ring 20. Said hollow cylinder 5 comprises a plurality of openings 6 which leave there a top ring 8 and a lower ring 9 connected to each other by at least two helical strips 7 have opposite directions of the helix/propeller and integrated to each other in crossing areas 10. For that purpose, said openings 6 have a substantially rhombic shape and are distributed in staggered arrangement throughout the wall of the hollow cylinder 5.

In the example shown, two helical strips 7 exist having an helix direction and two other helical strips 7 having the opposite helix direction.

Said configuration of rhombic openings 6, helical strips 7 having opposite helix direction and integral crossing areas 10 provide a sufficient elastic force having a reduced hollow cylinder wall thickness, the force is evenly distributed and the spires have no longer the trend to become entwisted and tangled with those of the adjacent elastic elements during their storage and handling. However, other configurations are possible (not shown). For example, a single opening, having an helical development which leaves within the hollow cylinder a top ring and a lower ring connected to each other by a single helical strip; or two or more openings having an helical development which leaves within the hollow cylinder as many other parallel helical strips connecting the top ring to the lower ring. Although the top and lower rings are useful, in some cases they are not essential, for example in the case where several helical strips integrally crossed exist. Although there would exist several parallel helical strips, they could be connected to each other by some sporadic intermediate connection suppressing one or the two rings.

The fact of offering the elastic element of injection moulded plastic material has the advantage of cutting down its production cost and to allow a configuration is drawn which makes its handling easier.

FIGS. 3 and 4 show the second example of embodiment of the invention in which the swivel pin 1 is of moulded plastic material and said hollow cylinder 5 similar to a skirt is integral with the swivel pin 1. In the variation shown in FIG. 3, the configuration of the openings 6 is the same disclosed with reference to the first example of embodiment shown in FIG. 2, that is to say said plurality of openings 6 has a rhombic shape and leaves a top ring 8 and a lower ring 9 connected to each other by at least two helical strips 7 which have opposite helix directions and which crosses each other and integrating to each other in crossing areas 10 only, in this second example of embodiment, the top ring 8 of the hollow cylinder 5 is integrated to said peripheral edge of the flange 4 or, in other words, ends of the helical strips 7 are integrally connected to the peripheral edge of the flange 4. On the other hand, it is obvious that here the configuration of the openings of the hollow cylinder admits same variations above mentioned with respect to the first example of embodiment.

The fact of providing the elastic element and the swivel pin integrated in a single piece of injection moulded plastic material has the additional advantage to reduce the number of parts making the assembly production, checking, storage and assembly easier which cuts down the final cost.

The swivel pin 1 as well in the first example of embodiment shown in FIG. 2 as in the second example of embodiment shown in FIG. 3 is preferably hollow, defining a cylindrical wall with an external surface of revolution 2 which is cylindrical or slightly conic and comprises four of said retaining configurations 3 distributed at even intervals around its second end 1b (best shown in FIG. 4), although a single retaining configuration 3 could be sufficient. The flange 4 comprises two pairs of diametrally opposed openings 11 diametrally opposed and facing retaining configurations 3 said openings 11 extending along a portion of said swivel pin 1 cylindrical wall. Said opening 11 are adapted to receive a mounting tool serving to press the swivel pin against the force of the elastic member 5 until making the second end 1b passes through a hole corresponding to the base 31, makes it turns and releases it to couple said retaining configurations 3 to the retaining configurations 30 of the base 31 as a bayonet lock or the like. It must be noted that the number and shape of the openings 11 depends on the characteristics of the tool, so, in some cases a single opening 11 could be enough.

While the swivel pin 1 of the first example of embodiment shown in FIG. 2 when separate is in fact a conventional swivel pin and it can be obtained of any material and any suitable process, the swivel pin 1 of the second example of embodiment shown in FIG. 3 is of same plastic material as the elastic element and its drawing is drawn at same time as that of the elastic member 5 to be integrally obtained in a single piece in an injection moulding process. In this case, said plastic material used in a High Tech material providing the characteristics of elasticity and strength required for the elastic element 5.

In the two examples of embodiment of this invention, the group formed by the elastic element 5 and the swivel pin 1 is built in the assembly for the hinged connection of a rear view mirror in a way very well-known within the sector and shown in FIG. 1 of the state of the art. In fact, an assembly elastic element 5 and swivel pin 1 according to the invention could replace a same conventional assembly if duly drawn for that purpose.

Above examples of embodiment and shown in the figures must be understood as illustrative and not limitative of the field of the invention, which is defined in claims appended.

1. Assembly for the hinged connection of a rear view mirror comprising a swivel pin (1) coaxially inserted though a ring-shaped holed element (20) connected to a frame (21) of said mirror, said swivel pin (1) having at a first end (1a) a flange (4) and at a second end (1b) at least a retaining configuration (3) adapted for being fixed on a corresponding retaining configuration (30) of a base (31) connected to a vehicle, an elastic member being arranged between said flange (4) and a support (22) of said holed element (20) acting by compression in a direction parallel to the axis of the swivel pin (1) to secure a contact under pressure between a lower part (23) of the holed element (20) and a seat (32) of said base (31), with the possibility of turning within an angle limited by respective stops, characterized in that said elastic member comprises a hollow cylinder (5) of moulded plastic material arranged as a skirt, from the peripheral edge (4) towards said second end (1b) of the swivel pin (1), coaxially to it, said hollow cylinder (5) being provided with at least an opening (6) having a suitable configuration to provide the hollow cylinder (5) with an elastic property, and said at least one opening (6) defining in the hollow cylinder (5) at least one helical strip (7).

2. Assembly according to claim 1, characterized in that the hollow cylinder (5) comprises a plurality of openings (6) defining at least two helical strips (7).

3. Assembly according to claim 2, characterized in that said at least two helical strips (7) have opposite helix directions and are crossing each other integrating each other in crossing areas (10).

4. Assembly, according to claim 1, characterized in that each helical strip (7) has one end integrally connected to a top ring (8) and another end integrally connected to a lower ring (9).

5. Assembly, according to claim 1, characterized in that the swivel pin (1) is hollow and defines a cylindrical wall with an external surface of revolution (2).

6. Assembly, according to claim 1, characterized in that the flange (4) comprises at least two openings (11) adapted to receive a mounting tool.

7. Assembly, according to claim 1, characterized in that it comprises several retaining configurations (3) distributed at even intervals around said second end (1b) of the swivel pin (1) and in that the flange (4) comprises other openings (11) diametrally opposed two by two, adapted to receive a mounting tool.

8. Assembly according to claim 6, characterized in that each opening (11) is extended along a portion of the swivel pin (1) cylindrical wall.

9. Assembly according to claim 1, characterized in that the swivel pin (1) is of a moulded plastic material and in that said hollow cylinder (5) similar to a skirt is integral with said swivel pin (1).

10. Assembly according to claim 9, characterized in that each helical strip (7) has one end integrally connected to the peripheral edge of the flange (4) and another end integrally connected to a lower ring (9).

11. Assembly, according to claim 2, characterized in that each helical strip (7) has one end integrally connected to a top ring (8) and another end integrally connected to a lower ring (9).

12. Assembly, according to claim 3, characterized in that each helical strip (7) has one end integrally connected to a top ring (8) and another end integrally connected to a lower ring (9).

13. Assembly, according to claim 7, characterized in that each opening (11) is extended along a portion of the swivel pin (1) cylindrical wall.
